(19) United States
(12) Patent Application Publication
(10) Pub. No.: US 2006/0265919 A1
(43) Pub. Date: Nov. 30, 2006

(54) Transparent light-conducting module

(76) Inventor: Hui-Tung Huang, Kaohsiung (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/207,762

(22) Filed: Aug. 22, 2005

(30) Foreign Application Priority Data
May 30, 2005 (TW) 094117714

(51) Int. Cl. G09F 13/18

(52) U.S. Cl. 40/546

(57) ABSTRACT

A transparent light-conducting module includes a transparent plate and a sheet light source. The transparent plate has at least one predetermined pattern, which has at least one oblique side. The sheet light source is disposed on at least one lateral side of the transparent plate. The lights emitted by the sheet light source can penetrate through the transparent plate, so that the transparent plate appears bright. The oblique sides of the predetermined pattern can refract the lights from the sheet light source to present a different visual appearance and brightness from the transparent plate around it, thus presenting an extremely aesthetic stereoscopic effect. Therefore, the transparent light-conducting module may be disposed at any location to be marked or advertised for achieving quite a remarkable or advertising effect. Moreover, the elements of the transparent light-conducting module are simple and easy to assemble.

### BACKGROUND OF THE INVENTION

1. Field of the Invention

The present invention relates to a light-conducting module, and in particular, to a transparent light-conducting module.

2. Description of the Related Art

With reference to FIG. 1, a schematic view of a conventional advertising signboard is shown. The conventional advertising signboard 10 comprises an outer frame 11, two advertising panels 12, 13 and a plurality of lamps 14, 15, 16. The two advertising panels 12, 13 are disposed on the two sides of the outer frame 11, typically there are patterns or characters on the advertising panels 12, 13 so as to achieve advertising effect. These lamps 14, 15, 16 are disposed inside the outer frame 11 and between the two advertising panels 12, 13 to generate light and illuminate the two advertising panels 12, 13, such that the advertising effect can also be achieved by the advertising signboard 10 even at night.

However, since the conventional advertising signboard 10 has to be provided with lamps, the overall volume of the advertising signboard is relatively large. Moreover, because the commercially available advertising signboards are largely identical in structure, no great changes are found in their structures. Therefore, only different changes of characters and patterns can be made on the two advertising panels, which, however, are confined to merely modifications of characters, patterns or colors on the surfaces but have no stereoscopic effect.

Accordingly, it is necessary to provide a transparent light-conducting module to solve the above-mentioned problems.

### SUMMARY OF THE INVENTION

One object of the invention is to provide a transparent light-conducting module. The transparent light-conducting module comprises a transparent plate and a sheet-like light source. The transparent plate has at least one predetermined pattern. The predetermined pattern has at least one oblique side. The sheet-like light source is disposed on at least one lateral side of the transparent plate.

Another object of the invention is to provide a transparent light-conducting module. The transparent light-conducting module comprises a transparent plate and a sheet-like light source. The transparent plate has at least one groove and at least one predetermined pattern. The predetermined pattern has at least one oblique side. The sheet-like light source is disposed in the groove of the transparent plate.

By utilizing the transparent light-conducting module of the invention, the lights emitted by the sheet-like light source can penetrate through the transparent plate, so that the transparent plate appears bright. The oblique sides of the predetermined pattern can refract the lights from the sheet-like light source to present a different visual perception and brightness from the transparent plate around it, thus presenting an extremely aesthetic stereoscopic effect. Therefore, the transparent light-conducting module of the present invention may be disposed at any location to be marked or advertised for achieving quite a marking or advertising effect. Moreover, the elements of the transparent light-conducting module of the invention are simple and easy to assemble.

### BRIEF DESCRIPTION OF THE DRAWINGS

FIG. 1 is a schematic view of a conventional advertising signboard;

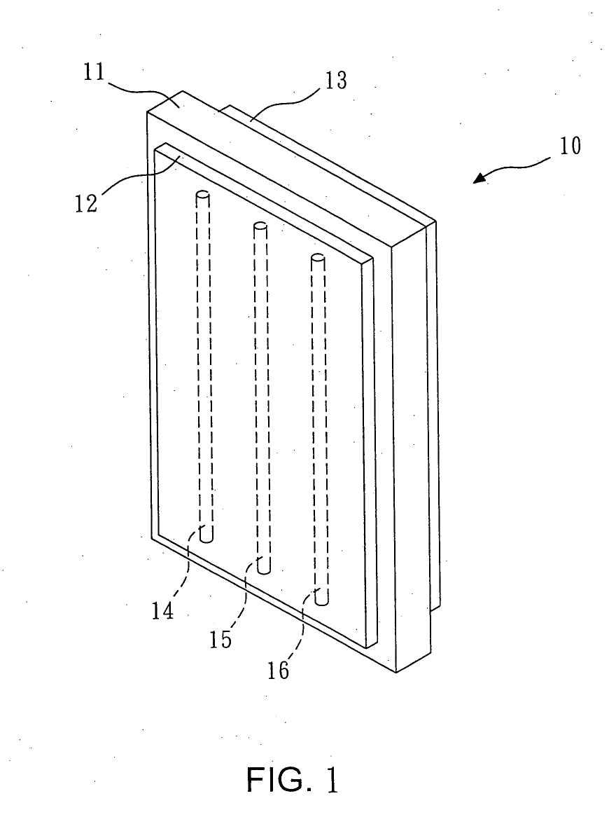

FIG. 2 is an exploded schematic view of the transparent light-conducting module, according to a first embodiment of the invention;

FIG. 3 is an assembled schematic view of the transparent light-conducting module, according to the first embodiment of the invention;

FIG. 4 is a schematic view of the transparent light-conducting module, according to a second embodiment of the invention;

FIG. 5 is a schematic view of the transparent light-conducting module, according to a third embodiment of the invention;

FIG. 6 is a schematic view of the transparent light-conducting module, according to a fourth embodiment of the invention;

FIG. 7 is an exploded schematic view of the transparent light-conducting module, according to a fifth embodiment of the invention;

FIG. 8 is an assembled schematic view of the first side of the transparent light-conducting module, according to the fifth embodiment of the invention; and

FIG. 9 is an assembled schematic view of the second side of the transparent light-conducting module, according to the fifth embodiment of the invention.

### DETAILED DESCRIPTION OF THE INVENTION

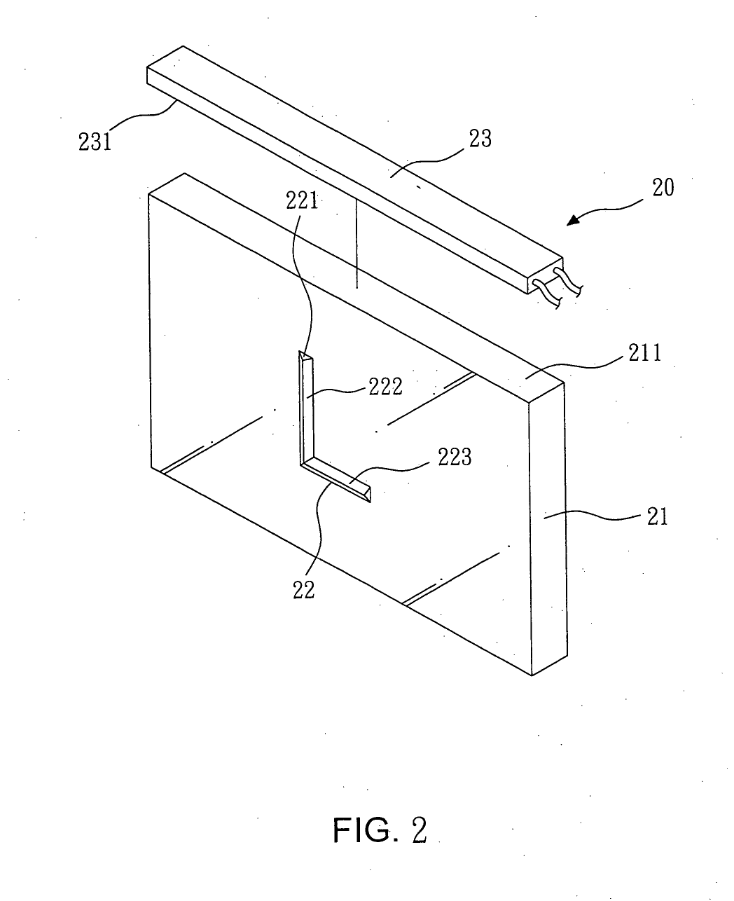

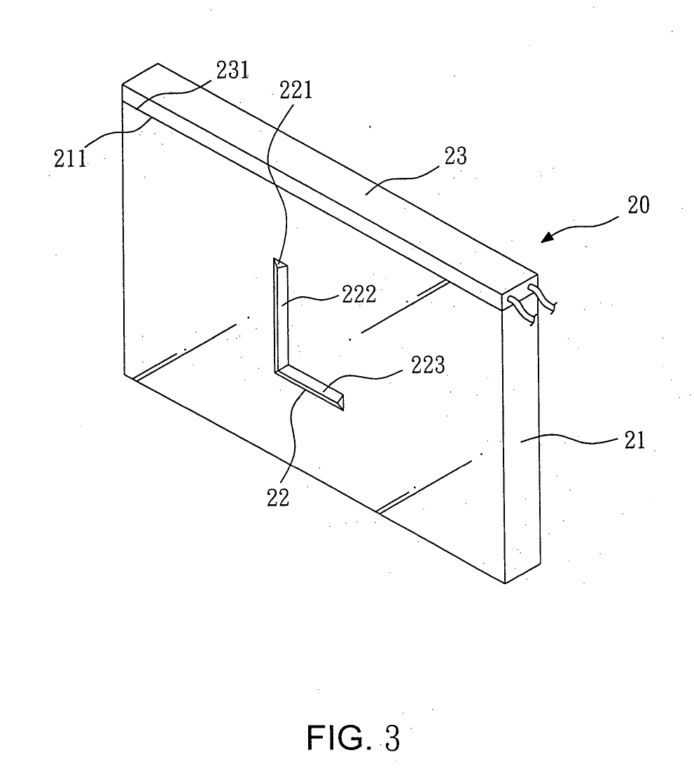

Referring to FIGS. 2 and 3, schematic views of the transparent light-conducting module according to a first embodiment of the invention are shown. According to the first embodiment of the invention, the transparent light-conducting module 20 comprises a transparent plate 21 and a sheet-like light source 23. The transparent plate 21 may be made from light-transmissive materials such as glass, acrylic board. The transparent plate 21 has at least one predetermined pattern 22 therein. In this embodiment, the predetermined pattern 22 is indicated by L. The predetermined pattern 22 is designed with a plurality of oblique sides 221, 222, 223, etc., to achieve stereoscopic effect. The predetermined pattern 22 may be formed on the surface of or inside of the transparent plate 21. These oblique sides 221, 222, 223, etc. may be formed by etching or other processes.

The sheet-like light source 23 is disposed on at least one lateral side of the transparent plate 21. The sheet-like light source 23 may be so-called light-emitting materials such as LED, CCFL-cold cathode lamp, EL-inorganic light emitter, OLED/PLED-organic light emitter and the like. The sheet-like light source 23 has a light-emitting surface 231 for emitting light. The light-emitting surface 231 is tightly attached to a first lateral side 211 of the transparent plate 21. The lights emitted by the light-emitting surface 231 of the sheet-like light source 23 can penetrate through the transparent plate 21 so that the transparent plate 21 appears bright. The oblique sides 221, 222 and 223 of the predetermined pattern 22 are opposite to the light-emitting surface 231 of the sheet-like light source 23, such that these oblique sides 221, 222 and 223 can refract the lights from the light-emitting surface 231 of the sheet-like light source 23 to present a different visual appearance and brightness from the transparent plate 21 around it, thus presenting an extremely aesthetic stereoscopic effect.

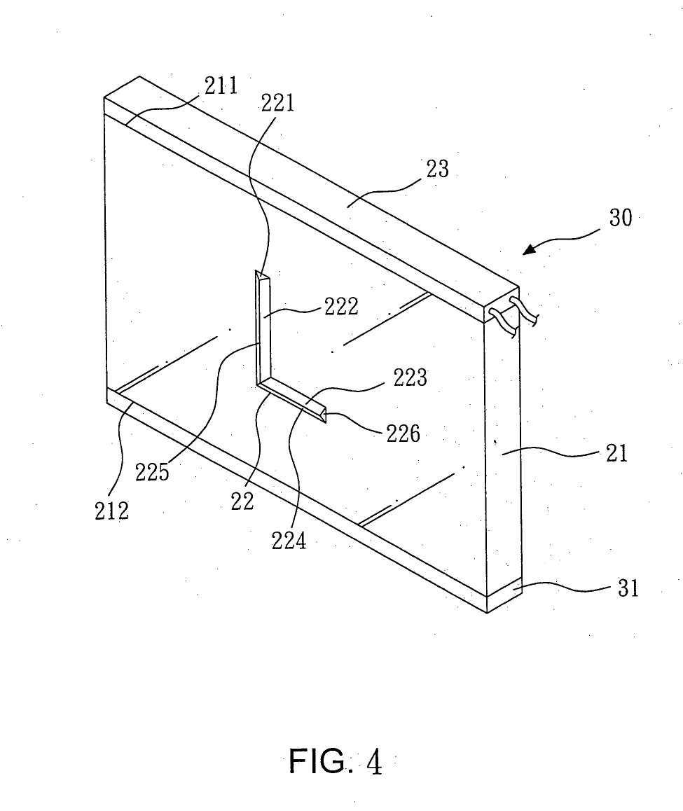

Referring to FIG. 4, a schematic view of the transparent light-conducting module according to a second embodiment of the invention is shown. According to the second embodiment of the invention, the transparent light-conducting module 30 comprises a transparent plate 21, a sheet-like light source 23 and a reflecting plate 31. The transparent plate 21 and the sheet-like light source 23 are the same as the transparent light-conducting module 20 in the first embodiment, and will not be repeated herein. The reflecting plate 31 is disposed on a second lateral side 212 of the transparent plate 21. The second lateral side 212 is opposite to the first lateral side 211. Therefore, the reflecting plate 31 is opposite to the sheet-like light source 23, such that the lights from the sheet-like light source 23 can be reflected back to the transparent plate 21 to increase the brightness of the transparent plate 21. Moreover, the other oblique sides 224, 225, 226, etc. of the pattern 22 can refract the lights from the reflecting plate 31.

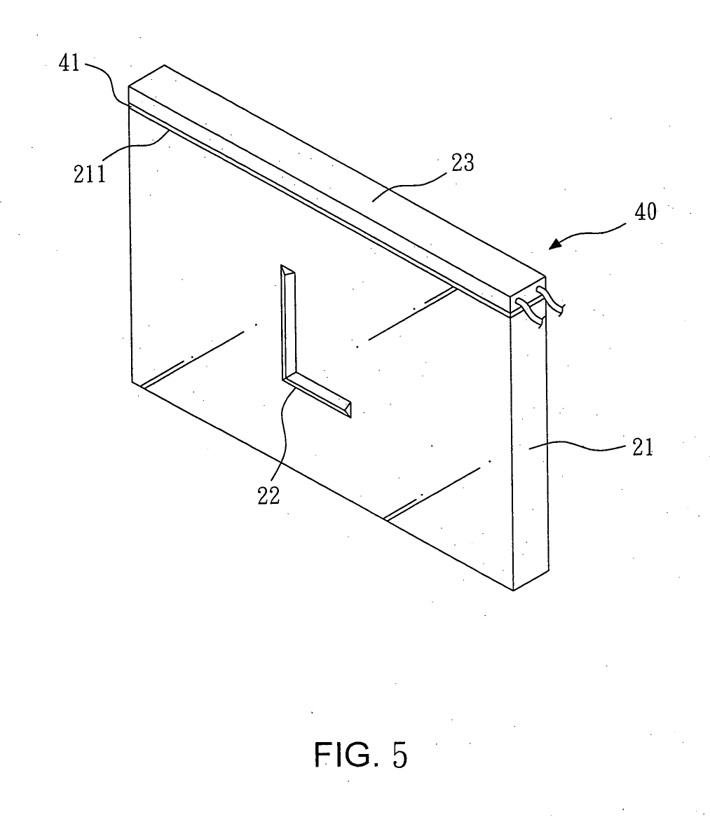

Referring to FIG. 5, a schematic view of the transparent light-conducting module according to a third embodiment of the invention is shown. According to the third embodiment of the invention, the transparent light-conducting module 40 comprises a transparent plate 21, a sheet-like light source 23 and a colored light-transmissive film 41. The transparent plate 21 and the sheet-like light source 23 are the same as the transparent light-conducting module 20 in the first embodiment. The colored light-transmissive film 41 is disposed between the sheet-like light source 23 and the first lateral side 211 of the transparent plate 21. The colored light-transmissive film 41 may be a light-transmissive film of any color, whereby the lights from the sheet-like light source 23 can be changed to any color and different colors can be set in segments in order to improve the visual effect.

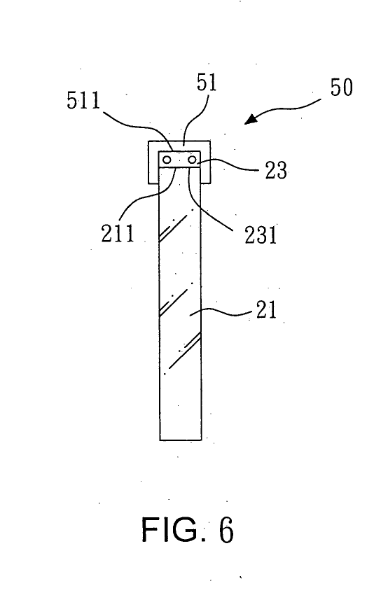

Referring to FIG. 6, a schematic view of the transparent light-conducting module according to a fourth embodiment of the invention is shown. According to the fourth embodiment of the invention, the transparent light-conducting module 50 comprises a transparent plate 21, a sheet-like light source 23 and an inverse u-shaped frame 51. The transparent plate 21 and the sheet-like light source 23 are the same as the transparent light-conducting module 20 in the first embodiment. The inverse u-shaped frame 51 has a bottom surface 511 on which the sheet-like light source 23 is disposed. The light-emitting surface 231 of the sheet-like light source 23 is also tightly attached to the first lateral side 211 of the transparent plate 21. Therefore, the inverse u-shaped frame 51 not only can protect the sheet-like light source 23, but also can collect the lights from the sheet-like light source 23 downward in order to increase the brightness. In addition, the inverse u-shaped frame 51 may block lateral lights from the sheet-like light source 23, so from an overall view, no lateral lights from the sheet-like light source 23 will be observed, and the aesthetic effect of the transmissive module 50 may be improved.

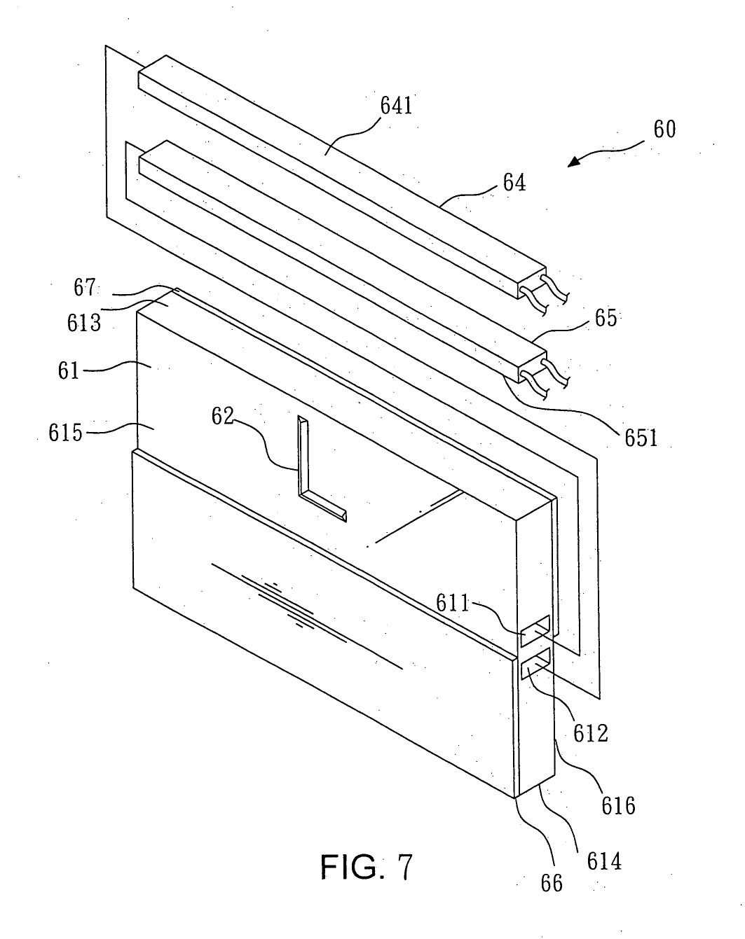

Referring to FIGS.7, 8 and 9, a schematic view of the transparent light-conducting module according to a fifth embodiment of the invention is shown. According to the fifth embodiment of the invention, the transparent light-conducting module 60 comprises a transparent plate 61 and two sheet-like light sources 64, 65. The transparent plate 61 has at least one predetermined pattern and at least one groove. In this embodiment, the transparent plate 61 has two predetermined patterns 62, 63 and two grooves 611, 612. Similarly, the two predetermined patterns 62, 63 are indicated by L, each having a plurality of oblique sides.

The two grooves 611, 612 are disposed between the two predetermined patterns 62 and 63. The two sheet-like light sources 64, 65 are disposed in the grooves 611, 612 of the transparent plate 61 respectively. The two sheet-like light sources 64, 65 have a light-emitting surface 641, 651 respectively. Wherein, the light-emitting surface 641 of the sheet-like light source 64 faces towards the pattern 62, while the light-emitting surface 651 of the sheet-like light source 65 faces towards the pattern 63. Therefore, the two sheet-like light sources 64, 65 can respectively emit light to the two patterns 62, 63 that may be designed into different patterns to give different displaying effects.

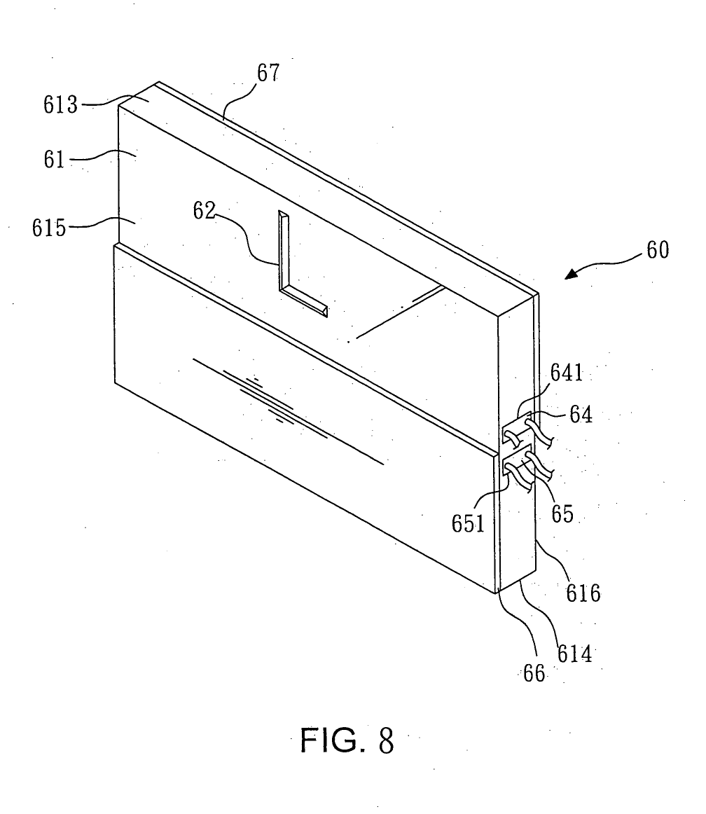

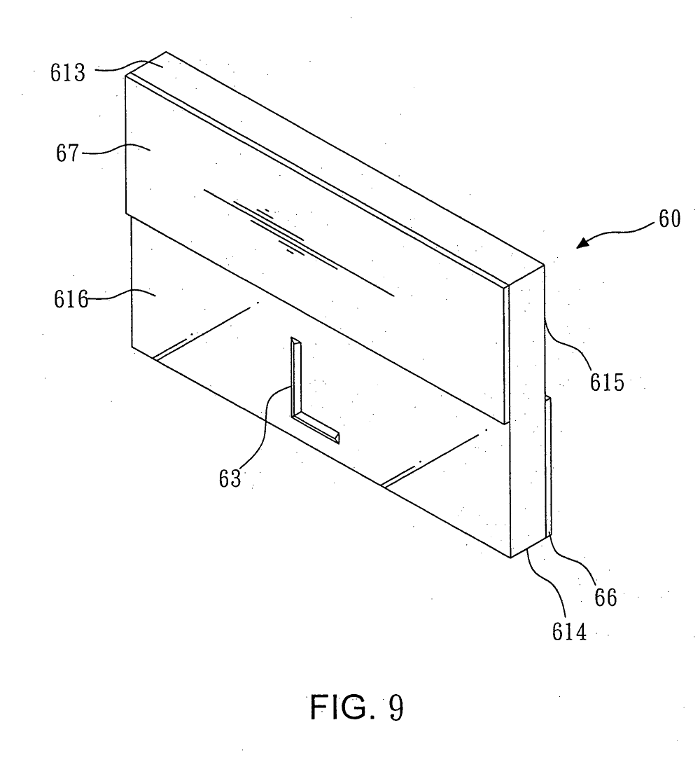

The transparent light-conducting module 60 in the fifth embodiment of the invention further comprises a first film 66 and a second film 67. The first film 66 is disposed at the lower part of a first side 615 of the transparent plate 61, and the second film 67 is disposed at the upper part of a second side 616 of the transparent plate 61. The first film 66 and the second film 67 are hazy films for achieving the effect for preventing the lights from transmitting. Referring to FIG. 8, it is observed from the first side 615 of the transparent plate 61, the transparent light-conducting module 60 only displays the pattern 62 while the pattern 63 is hidden from view since the lower part of the first side 615 is blocked by the first film 66. Similarly, referring to FIG. 9, it observed from the second side 616 of the transparent plate 61, the transparent light-conducting module 60 only displays the pattern 63 while the pattern 62 is hidden from view since the upper part of the second side 616 is blocked by the second film 67. Therefore, the transparent light-conducting module 60 in the fifth embodiment of the invention has the effect of dual displaying.

In addition, the transparent light-conducting module 60 in the fifth embodiment of the invention may further comprise at least one reflecting plate (not shown), which is disposed on at least one lateral side (e.g. lateral sides 613, 614) of the transparent plate. The lateral sides 613, 614 are opposite to the light-emitting surfaces 641, 651 of the two sheet-like light sources 64, 65 respectively, for reflecting the lights from the two sheet-like light sources 64, 65 back to the two patterns 62, 63 to enhance the displaying effect.

Furthermore, the transparent light-conducting module 60 in the fifth embodiment of the invention may further comprise at least one colored light-transmissive film (not shown), which may be disposed between the light-emitting surfaces 641, 651 of the two sheet-like light sources 64, 65 and the transparent plate 61, i.e., within the groove 611 above the light-emitting surface 641 and within the groove 612 below the light-emitting surface 651. Similarly, the colored light-transmissive film may be a light-transmissive film of any color, whereby the lights from the sheet-like light sources 64, 65 may be changed to any color and different colors may be set in segments in order to improve the visual effect.

Thus, the transparent light-conducting module of the invention may be disposed at any location to be marked (e.g. doorplate, safety sign, indication and traffic sign, etc.) or any location to be advertised, for achieving quite a remarkable or advertising effect. Moreover, the elements of the transparent light-conducting module of the invention are simple and easy to assemble.

While an embodiment of the present invention has been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims.

1. A transparent light-conducting module, comprising:
a transparent plate, having at least one predetermined pattern, the predetermined patent having at least one side oblique side; and
a sheet light source, disposed on at least one lateral side of the transparent plate.

2. The transparent light-conducting module according to claim 1, wherein the sheet light source has a light-emitting surface tightly attached to a first lateral side of the transparent plate.

3. The transparent light-conducting module according to claim 2, further comprising a reflecting plate disposed on a second lateral side of the transparent plate, the second lateral side being opposite to the first lateral side.

4. The transparent light-conducting module according to claim 2, wherein the oblique side of the predetermined pattern is opposite to the light-emitting surface of the sheet light source, such that the oblique side refracts the lights from the sheet light source.

5. The transparent light-conducting module according to claim 1, further comprising a colored light-transmissive film disposed between the sheet light source and the lateral side of the transparent plate.

6. The transparent light-conducting module according to claim 1, further comprising an inverse u-shaped frame, wherein the sheet light source is disposed on a bottom face of the inverse u-shaped frame.

7-12. (canceled)
